(19) United States
(12) Patent Application Publication
(10) Pub. No.: US 2013/0004373 A1
(43) Pub. Date: Jan. 3, 2013

(54) SYSTEM FOR TREATING SELENIUM-CONTAINING LIQUID, WET FLUE GAS DESULFURIZATION DEVICE, AND METHOD FOR TREATING SELENIUM-CONTAINING LIQUID

(75) Inventors: Hiroyuki Akiho, Kanagawa (JP); Shigeo Ito, Kanagawa (JP); Hiromitsu Matsuda, Kanagawa (JP)

(73) Assignee: CENTRAL RESEARCH INSTITUTE OF ELECTRIC POWER INDUSTRY, Tokyo (JP)

(21) Appl. No.: 13/583,643

(22) PCT Filed: Mar. 29, 2011
(86) PCT No.: PCT/JP2011/057828

§ 371 Date: Sep. 10, 2012

(30) Foreign Application Priority Data
Mar. 29, 2010 (JP) 2010-076438

(51) Int. Cl. C02F 1/58; B01D 53/77; B01D 53/50; G05B 1/00; C02F 1/70

(52) U.S. Cl. 422/105; 210/96.1; 210/739

(57) ABSTRACT

A system for treating a selenium-containing liquid includes a concentration measurement element 15 for measuring the concentration of peroxodisulfuric acid and the concentration of tetravalent selenium in the selenium-containing liquid; a setting element 21 for setting the feed amount of bivalent manganese based on the concentrations of peroxodisulfuric acid and tetravalent selenium, and a reaction rate constant ratio which is the ratio of a reaction rate constant in a reaction between bivalent manganese and peroxodisulfuric acid to a reaction rate constant in a reaction between tetravalent selenium and peroxodisulfuric acid; and an addition element 14 for adding bivalent manganese to the selenium-containing liquid such that the bivalent manganese in the selenium-containing liquid is maintained in the above feed amount. Bivalent manganese is added to the selenium-containing liquid by the addition element, whereby oxidation of tetravalent selenium to hexavalent selenium is suppressed.

### TECHNICAL FIELD

This invention relates to a system for treating a selenium-containing liquid, a wet flue gas desulfurization device, and a method for treating a selenium-containing liquid.

### BACKGROUND ART

So far, coal used for coal-fired thermal power generation has generally contained a trace amount of selenium. When the coal is burned in a coal-fired power plant, the selenium in the coal enters coal ash collected by an electrostatic precipitator of flue gas treatment equipment, or enters an absorbing liquid (desulfurization slurry) of a wet flue gas desulfurization device. Under the effluent standards, the value of selenium for discharge is set (0.1 mg/L). Thus, the absorbing liquid of the wet flue gas desulfurization device may also have to be treated in order to fulfill the standard value.

It is known that at least one element selected from Ti and Mn is added to the selenium-containing liquid to suppress the formation of hexavalent selenium (see, for example, Patent Document 1).

### PRIOR ART DOCUMENTS

### Patent Documents

Patent Document 1: JP-A-2009-160568

### SUMMARY OF THE INVENTION

### Problems to be Solved by the Invention

According to the method for treating a selenium-containing liquid which is described in Patent Document 1, the selenium-containing liquid can be treated without a high cost. However, the problem is involved that tetravalent selenium (tetravalent selenite ions: SeO₃²⁻) be oxidized to hexavalent selenium (hexavalent selenate ions: SeO₄²⁻) in the selenium-containing liquid.

The challenge for the present invention is, therefore, to solve the above-mentioned problem of the conventional technology, thereby providing a system for treating a selenium-containing liquid, a wet flue gas desulfurization device, and a method for treating a selenium-containing liquid, which can suppress the formation of hexavalent selenium in a selenium-containing liquid more accurately.

### Means for Solving the Problems

A system for treating a selenium-containing liquid according to the present invention comprises a first concentration measurement means for measuring the concentration of peroxodisulfuric acid in the selenium-containing liquid; a second concentration measurement means for measuring the concentration of tetravalent selenium in the selenium-containing liquid; a setting means for setting a bivalent manganese concentration based on the concentration of peroxodisulfuric acid and the concentration of tetravalent selenium, a reaction rate constant in a decomposition reaction of peroxodisulfuric acid, and a reaction rate constant ratio which is the ratio of a reaction rate constant in a reaction between bivalent manganese and peroxodisulfuric acid to a reaction rate constant in a reaction between tetravalent selenium and peroxodisulfuric acid; and an addition means for adding bivalent manganese to the selenium-containing liquid such that the selenium-containing liquid has the bivalent manganese concentration, bivalent manganese being added to the selenium-containing liquid by the addition means such that the bivalent manganese concentration is reached, whereby oxidation of tetravalent selenium to hexavalent selenium is suppressed. In the present invention, the bivalent manganese concentration can be set such that the desired ratio of suppression of hexavalent selenium formation, by providing the setting means for setting the bivalent manganese concentration based on the concentration of peroxodisulfuric acid and the concentration of tetravalent selenium, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid. Moreover, bivalent manganese is added to the selenium-containing liquid by the addition means such that the selenium-containing liquid has the above bivalent manganese concentration. Hence, the oxidation of tetravalent selenium to hexavalent selenium after a lapse of the desired time can be suppressed accurately.

Preferably, the system for treating a selenium-containing liquid further comprises a temperature measurement means for measuring the temperature of the selenium-containing liquid, and the setting means sets the reaction rate constant in the decomposition reaction of peroxodisulfuric acid and the reaction rate constant ratio based on the measured temperature. Since the reaction rate constant and the reaction rate constant ratio are temperature-dependent, whenever the bivalent manganese concentration is set by the setting means, the temperature of the selenium-containing liquid is measured to set the reaction rate constant ratio. By so doing, the bivalent manganese concentration can be set more accurately. Thus, the oxidation of tetravalent selenium to hexavalent selenium can be suppressed more reliably.

It is also preferred for the setting means to estimate the amount of tetravalent selenium deposited on manganese dioxide formed by the reaction between bivalent manganese and peroxodisulfuric acid, subtract the estimated amount of tetravalent selenium from the total amount of tetravalent selenium to find the concentration of tetravalent selenium, and set the bivalent manganese concentration based on the concentration of tetravalent selenium. The tetravalent selenium deposited on the manganese dioxide is not oxidized to hexavalent selenium. Thus, this amount of tetravalent selenium adsorbed is estimated, and the estimated amount of tetravalent selenium is subtracted from the total amount of tetravalent selenium, whereby the amount of tetravalent selenium oxidizable is estimated. By this procedure, the bivalent manganese concentration can be set more accurately. Hence, the oxidation of tetravalent selenium to hexavalent selenium can be suppressed more reliably.

Preferably, the system for treating a selenium-containing liquid further comprises a recovery means for recovering the manganese dioxide from the selenium-containing liquid to which the bivalent manganese has been added; and a dissolution means for dissolving the manganese dioxide, which has been recovered by the recovery means, with an acid to form bivalent manganese. The recovered manganese dioxide is dissolved and restored to bivalent manganese, which can be utilized again as a bivalent-manganese-containing liquid for suppressing the oxidation of tetravalent selenium. By this measure, the utilization efficiency of manganese can be increased, and the cost can be lowered.

A wet flue gas desulfurization device according to the present invention is a wet flue gas desulfurization device for removing sulfur oxides in an exhaust gas, comprising: a first concentration measurement means for measuring the concentration of peroxodisulfuric acid in a desulfurization slurry of the wet flue gas desulfurization device, and a second concentration measurement means for measuring the concentration of tetravalent selenium in the desulfurization slurry of the wet flue gas desulfurization device; a setting means for setting a bivalent manganese concentration based on the concentration of peroxodisulfuric acid and the concentration of tetravalent selenium, a reaction rate constant in a decomposition reaction of peroxodisulfuric acid, and a reaction rate constant ratio which is the ratio of a reaction rate constant in a reaction between bivalent manganese and peroxodisulfuric acid to a reaction rate constant in a reaction between tetravalent selenium and peroxodisulfuric acid; and an addition means for adding bivalent manganese to the selenium-containing liquid such that the selenium-containing liquid has the bivalent manganese concentration, wherein bivalent manganese is added to the selenium-containing liquid by the addition means such that the bivalent manganese concentration is reached, whereby oxidation of tetravalent selenium to hexavalent selenium is suppressed.

Preferably, the wet flue gas desulfurization device further comprises a recovery section for recovering the manganese dioxide from a supernatant liquid in gypsum and the supernatant liquid separated by a gypsum thickener which performs solid-liquid separation of the desulfurization slurry from the wet flue gas desulfurization device. The recovery of manganese dioxide from the supernatant liquid makes it possible to inhibit the entry of manganese dioxide into gypsum due to the reuse of the supernatant liquid and form gypsum of high quality comparable to that of gypsum obtained from a conventional wet flue gas desulfurization device which does not add bivalent manganese to a desulfurization slurry.

Preferably, the wet flue gas desulfurization device is provided with a dissolution means for dissolving the manganese dioxide, which has been recovered by the recovery section, with an acid to form bivalent manganese. The recovered manganese dioxide is dissolved and restored to bivalent manganese, which can be utilized again as a bivalent-manganese-containing liquid for suppressing the oxidation of tetravalent selenium. By this measure, the utilization efficiency of manganese can be increased, and the cost can be lowered.

A method for treating a selenium-containing liquid according to the present invention comprises: a concentration measurement step of measuring the concentration of peroxodisulfuric acid and the concentration of tetravalent selenium in the selenium-containing liquid; a setting step of setting a bivalent manganese concentration based on the concentration of peroxodisulfuric acid and the concentration of tetravalent selenium, a reaction rate constant in a decomposition reaction of peroxodisulfuric acid, and a reaction rate constant ratio which is the ratio of a reaction rate constant in a reaction between bivalent manganese and peroxodisulfuric acid to a reaction rate constant in a reaction between tetravalent selenium and peroxodisulfuric acid; and an addition step of adding bivalent manganese to the selenium-containing liquid such that the selenium-containing liquid has the bivalent manganese concentration, bivalent manganese being added to the selenium-containing liquid, whereby oxidation of tetravalent selenium to hexavalent selenium is suppressed.

### BRIEF DESCRIPTION OF THE DRAWINGS

FIG. 1 is a graph showing the results of Experimental Example 1.

FIG. 2 is a graph showing the results of Experimental Example 2.

FIG. 3 is a graph showing the results of Experimental Example 2.

FIG. 4 is a graph showing the results of Experimental Example 3.

FIG. 5 is a graph showing the results of Experimental Example 3.

FIG. 6 is a graph showing the results of Experimental Example 3.

FIG. 7 is a graph showing the results of Experimental Example 4.

FIG. 8 is a graph showing the results of Experimental Example 5.

FIG. 9 is a graph showing the results of Experimental Example 6.

FIG. 10 is a graph showing the results of Experimental Example 6.

FIG. 11 is a graph showing the results of Experimental Example 7.

FIG. 12 is a graph showing the results of Experimental Example 8.

FIGS. 13(a) to 13(c) are graphs showing the results of Experimental Example 9.

FIG. 14 is a graph showing the bivalent manganese holding concentration versus the selenium oxidation ratio.

FIG. 15 is a schematic view of a wet flue gas desulfurization device for illustrating a system for treating a selenium-containing liquid.

FIG. 16 is a schematic view of another wet flue gas desulfurization device for illustrating the system for treating a selenium-containing liquid.

### MODES FOR CARRYING OUT THE INVENTION

### Method for Treating Selenium-Containing Liquid

A method for treating a selenium-containing liquid according to the present invention will now be described below.

The method for treating a selenium-containing liquid according to the present invention suppresses the oxidation of tetravalent selenium to hexavalent selenium in a selenium-containing liquid such as industrial waste water or wastewater from a west desulfurization device of a coal-fired power plant.

For example, the behavior of selenium in a desulfurization slurry within a wet flue gas desulfurization device will be explained. In a coal fired power plant, a combustion exhaust gas from a boiler is released to the atmosphere via a denitration device, an electrostatic precipitator, and the wet flue gas desulfurization device. The combustion exhaust gas from the boiler contains gaseous selenium, and the gaseous selenium is passed through the denitration device, the electrostatic precipitator, etc., and introduced into the wet flue gas desulfurization device.

The selenium introduced into the wet flue gas desulfurization device dissolves in the desulfurization slurry (a slurry containing limestone and slaked lime as desulfurizing agents, and gypsum as the product) within the wet flue gas desulfurization device, and exists initially as tetravalent selenium. The wet flue gas desulfurization device is newly supplied with a slurry of limestone and slaked lime as desulfurizing agents and, at the same time, a part of the desulfurization slurry containing gypsum as the product is discharged. Thus, the desulfurization slurry resides for a long time (e.g., 50 hours or so) within the wet flue gas desulfurization device. During its residence within the wet flue gas desulfurization device, tetravalent selenium in the desulfurization slurry is oxidized to hexavalent selenium by peroxodisulfuric acid which is an oxidizing substance. Tetravalent selenium can be easily treated by a conventional coagulation-sedimentation process, but if oxidized to hexavalent selenium, has posed the problem that the treatment of the hexavalent selenium requires a cost and labor. That is, hexavalent selenium is reduced to tetravalent selenium or zero-valent metallic selenium having no valence with the use of metallic iron as a reducing agent, and the tetravalent selenium or the metallic selenium is treated by the coagulation sedimentation process or the like. This is costly and laborious.

In the present embodiment, therefore, a bivalent manganese concentration, which can suppress and restrict the formation of hexavalent selenium in the selenium-containing liquid to the desired ratio after a lapse of the desired time, is set by a setting step. In order that the set bivalent manganese concentration can be held, bivalent manganese is added to the selenium-containing liquid, whereby the oxidation of tetravalent selenium to hexavalent selenium is suppressed and restricted to the desired ratio. The bivalent manganese concentration is set based on the concentration of peroxodisulfuric acid and the concentration of tetravalent selenium, a reaction rate constant in a decomposition reaction of peroxodisulfuric acid, and a reaction rate constant ratio which is the ratio of a reaction rate constant in a reaction between bivalent manganese and peroxodisulfuric acid to a reaction rate constant in a reaction between tetravalent selenium and peroxodisulfuric acid, as will be described later in detail.

The method for treating the selenium-containing liquid according to the present embodiment, therefore, comprises a concentration measurement step of measuring the concentration of peroxodisulfuric acid and the concentration of tetravalent selenium in the selenium-containing liquid; the setting step of setting the bivalent manganese concentration based on the concentration of peroxodisulfuric acid and the concentration of tetravalent selenium, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid; and an addition step of adding bivalent manganese to the selenium-containing liquid such that the bivalent manganese concentration is held in the selenium-containing liquid. For example, the peroxodisulfuric acid concentration and the tetravalent selenium concentration in the selenium-containing liquid at 50° C. are measured to obtain 1 mg/L as the tetravalent selenium concentration and 300 mg/L as the peroxodisulfuric acid concentration (concentration measurement step). Based on the reaction rate constant ratio which shows the ratio of the reaction rate constant in the reaction between bivalent manganese and peroxodisulfuric acid to the reaction rate constant in the reaction between tetravalent selenium and peroxodisulfuric acid (the reaction rate constant ratio is 4.27 if the temperature of the selenium-containing liquid is 50° C.), the reaction rate constant in the decomposition reaction of peroxodisulfuric acid (1.2×10⁻⁶ if the temperature of the selenium-containing liquid is 50° C.), the resulting selenium concentration of 1 mg/L, and the resulting peroxodisulfuric acid concentration of 300 mg/L, the bivalent manganese concentration is set at 0.9 mmol/L, if it is desired to obtain an oxidation ratio of 10% for oxidation to hexavalent selenium 48 hours later (setting step). Bivalent manganese is added to the selenium-containing liquid such that the set bivalent manganese concentration is attained (addition step).

The details of the setting step will be described below.

(Decomposition Reaction of Peroxodisulfuric Acid)

As described above, the tetravalent selenium in the desulfurization slurry of the wet flue gas desulfurization device is oxidized to hexavalent selenium during residence within the wet flue gas desulfurization device. This may be because the tetravalent selenium is oxidized by an oxidizing substance produced within the desulfurization device which is in an oxidizing atmosphere, whereby hexavalent selenium is formed.

The inventors of the present invention have found that this oxidizing substance is peroxodisulfuric acid. That is, the inventors of the present invention have found from the following Experimental Examples 1 to 4 that when peroxodisulfuric acid is decomposed into sulfate radicals and then into sulfate ions, the sulfate radicals deprive tetravalent selenium of electrons, whereby tetravalent selenium is oxidized to hexavalent selenium.

### Experimental Example 1

In the present Experimental Example, it was confirmed whether the oxidation of tetravalent selenium would proceed in the presence of a radical scavenger, namely, whether the oxidation reaction of tetravalent selenium was a reaction due to sulfate radicals.

Peroxodisulfuric acid (S₂O₈²⁻) decomposes into two molecules of sulfate ions (SO₄²⁻) and, during this process, generates sulfate radicals (SO₄⁻). In this case, an overall reaction during the decomposition of peroxodisulfuric acid is a two-electron transfer reaction as shown in the following formula (1). Actually, however, the reaction proceeds stepwise as in the following formulas (2) and (3):

Overall reaction

S₂O₈²⁻+H₂O→2SO₄²⁻+2H⁺+(½)O₂ (1)

Elementary reaction 1

S₂O₈²⁻+e⁻⁴→SO₄⁻+SO₄²⁻ (2)

Elementary reaction 2

SO₄⁺+e⁻→SO₄²⁻ (3)

The reaction of the formula (2) minimally occurs in terms of potential, but the reactivity of sulfate radicals produced according to the formula (2) is so high that the reaction of the formula (3) immediately occurs. Thus, the oxidation of tetravalent selenium may be attributed to its reaction with the sulfate radicals.

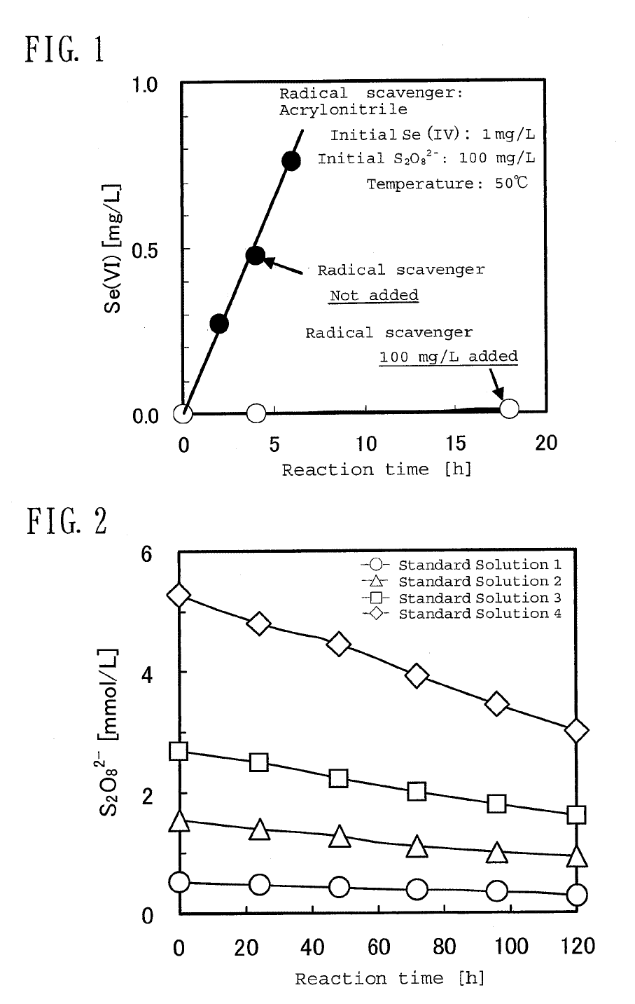

Thus, potassium peroxodisulfate (produced by KANTO CHEMICAL CO., INC., Product No. 32375-00) and selenium dioxide (produced by KANTO CHEMICAL CO., INC., Product No. 37025-30) were dissolved to prepare two standard samples having a peroxodisulfuric acid concentration of 100 mg/L and a tetravalent selenium concentration of 1 mg/L. To one of the samples, acrylonitrile (produced by Wako Pure Chemical Industries, Ltd., 014-00783) was added as a radical scavenger to a concentration of 100 mg/L, and the mixture was held with heating at 50° C. Under these conditions, changes in the selenium concentration were investigated. The results are shown in FIG. 1.

As shown in FIG. 1, when the radical scavenger was not added, the hexavalent selenium concentration increased, whereas when the radical scavenger was added, no increase in the hexavalent selenium concentration was observed. This is considered to be because sulfate radicals produced by the decomposition of peroxodisulfuric acid were trapped by the radical scavenger, and thus did not contribute to the oxidation of tetravalent selenium. Hence, the present Experimental Example showed that the oxidation of tetravalent selenium was due to the reaction with the sulfate radicals produced by the decomposition of peroxodisulfuric acid.

### Experimental Example 2

In the present Experimental Example, potassium peroxodisulfate (produced by KANTO CHEMICAL CO., INC., Product No. 32375-00) was dissolved to prepare standard solutions 1 to 4 of different peroxodisulfuric acid concentrations. These standard solutions were held at 50° C., and changes in the peroxodisulfuric acid concentration over time were investigated. The results are shown in FIG. 2. The standard solutions 1 to 4 had peroxodisulfuric acid concentrations of 0.52, 1.56, 2.60, and 5.20 mmol/L, respectively.

With all the standard solutions 1 to 4, as shown in FIG. 2, the peroxodisulfuric acid concentration decreased with the passage of the holding time. The results shown in FIG. 2 showed that peroxodisulfuric acid was decomposed and decreased over time.

Based on the aforementioned formula (2), the reaction rate r_{S2O82-} for the decomposition of peroxodisulfuric acid is expressed as follows:

r_{S2O82-}=dC_{S2O82-}/dt=−k₁C_{S2O82-} (4)

where k1 denotes a reaction rate constant.

Integration of this equation with respect to time t gives the following equations:

C_{S2O82-}=C_{S2O82-,0}e^{-k1t} (5)

In(C_{S2O82-}/C_{S2O82-,0})=k₁t (6)

where C_{S2O82-} represents the peroxodisulfuric acid concentration after a lapse of the time t, and C_{S2O82-,0} represents the peroxodisulfuric acid concentration in the initial stage (t=0).

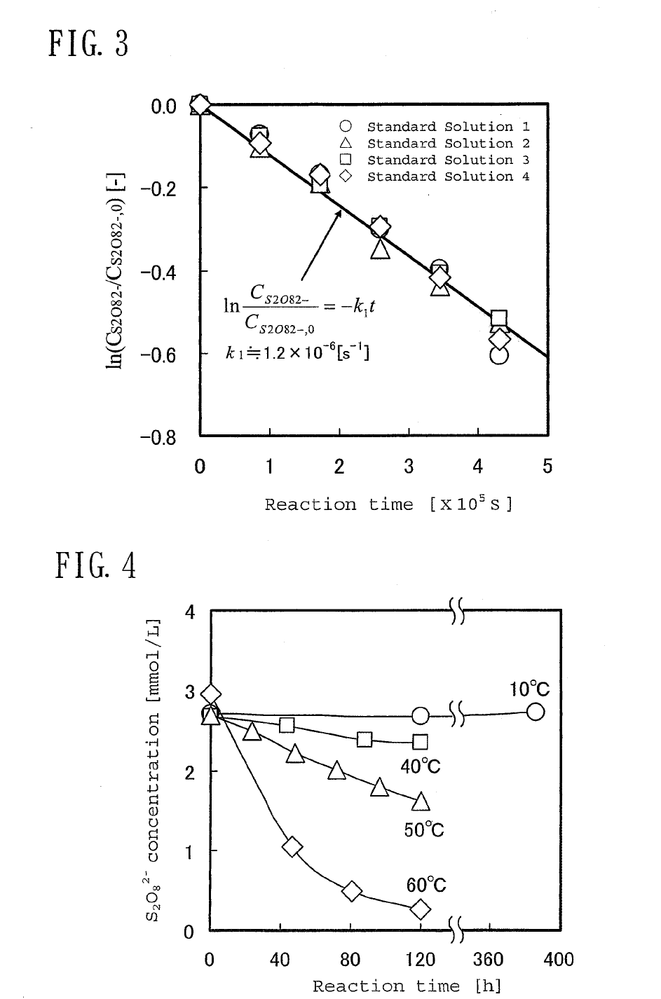

Then, in connection with the standard solutions 1 to 4 used in the present Experimental Example, the natural logarithms of the ratios between the initial peroxodisulfuric acid concentration and the peroxodisulfuric acid concentration at each holding time (i.e., the left side of the equation (6)) were plotted against the reaction time. The results are shown in FIG. 3.

As shown in FIG. 3, each plot of the standard solutions 1 to 4 formed a straight line. From the gradient of this straight line, the reaction rate constant k₁ in the decomposition reaction of peroxodisulfuric acid was calculated at about 1.2×10⁻⁶ (s⁻¹).

### Experimental Example 3

In the present Experimental Example, it was investigated whether the decomposition reaction of peroxodisulfuric acid had temperature dependence.

Potassium peroxodisulfate (produced by KANTO CHEMICAL CO., INC., Product No. 32375-00) was dissolved to prepare standard solutions 5 to 8 having a peroxodisulfuric acid concentration adjusted to about 2.6 mmol/L (500 mg/L). These standard solutions were held at 10° C., 40° C., 50° C., and 60° C., and changes in the peroxodisulfuric acid concentration over time were investigated. The results are shown in FIG. 4.

As shown in FIG. 4, when the temperature was low, for example, when the holding temperature was 10° C., the peroxodisulfuric acid concentration did not decrease, but remained nearly constant. The higher the temperature, the more rapidly the peroxodisulfuric acid concentration decreased. When the holding temperature was 60° C., for example, the peroxodisulfuric acid concentration decreased to about a third of the initial concentration in 40 hours.

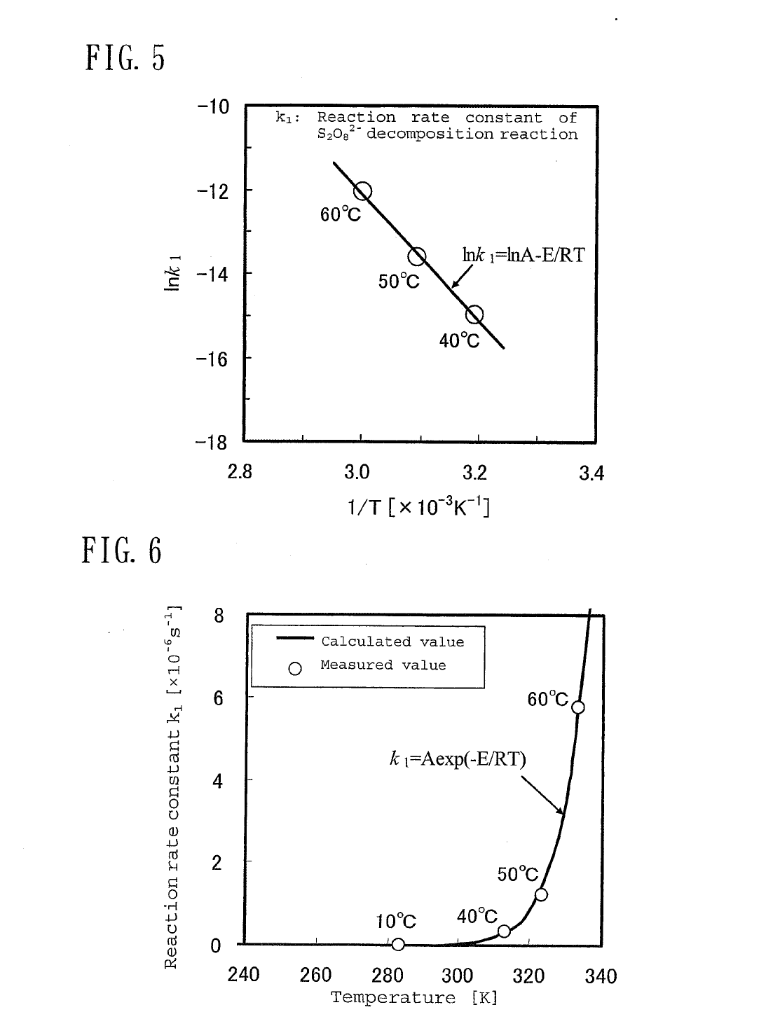

Based on the results shown in FIG. 4, the reaction rate constant k₁ at each holding temperature (K) was determined, and the natural logarithm of k₁ was plotted against the reciprocal of the temperature. The results are shown in FIG. 5. From FIG. 5, the plot of the experimental results on the standard solutions 5 to 8 was found to form a straight line. Thus, the decomposition reaction of peroxodisulfuric acid was found to be temperature-dependent in accordance with the following Arrhenius' equation:

Ink₁=InA−E/RT (7)

where A denotes the frequency factor, E denotes the activation energy (J), R denotes the gas constant (Jmol⁻¹K⁻¹), and T denotes the temperature (K). A and E are found from the gradient and intercept of the straight line in FIG. 5. A plot of k₁ versus the temperature (T(K)) is shown in FIG. 6. FIG. 6 shows that the value of k₁ can be determined by the temperature.

Based on the results of Experimental Examples 1 to 3, the rate of the decomposition reaction of peroxodisulfuric acid, namely, the rate of formation of sulfate radicals by peroxodisulfuric acid which oxidize tetravalent selenium, can be predicted, for example, if the concentration of peroxodisulfuric acid in the desulfurizing absorbing liquid within the desulfurization device and the temperature of the desulfurizing absorbing liquid are known.

### Experimental Example 4

In the present Experimental Example, the rate of the oxidation reaction of tetravalent selenium was investigated.

As stated earlier, the sulfate radicals (SO₄⁻) formed according to the formula (2) immediately deprive the surroundings of electrons, reacting as in the formula (3). If the supply source of the electrons in the formula (3) is tetravalent selenium, hexavalent selenium is considered to be formed according to the following reaction (formula (8)):

S₂O₈²⁻+e⁻→SO₄⁻+SO₄²⁻ (2)

Se(IV)O₃²⁻+2SO₄⁻+H₂O→Se(VI)O₄²⁻+2SO₄²⁻+2H⁺ (8)

If the reaction rate constants for the formula (2) and the formula (8) are designated as k₁ and k₂, respectively, the reaction rate rₛ₀₄₋ of the sulfate radicals is expressed as:

r_{SO4-}²=k₁C_{S2O82-}−2k₂C_{SeO32-}C_{SO4-}² (9)

The first term of the right side of the equation (9) refers to the formation velocity of the sulfate radicals, and the second term refers to the consumption velocity of the sulfate radicals. The reactivity of radicals, such as sulfate radicals, is so high that the formation velocity of the radicals and the consumption velocity of the radicals can generally be deemed to equal (nearly steady state). Thus, the following equation is obtained:

C_{SO4-}²=k₁C_{S2O32-}/2 k₂C_{SeO32-} (10)

Next, the reaction rate of hexavalent selenium, r_{SeO42-}, is rearranged using the equation (10) and the equation (5) to provide

$$\begin{matrix}{r}_{SeO 42} = d {C}_{SeO 42 -} / d t \\ = {k}_{2} {C}_{SeO 32 -} {C}_{SO 4 -}^{2} \\ = ( 1 / 2 ) {k}_{1} {C}_{S 2 O 82 -} \\ = ( 1 / 2 ) {k}_{1} {C}_{S 2 O 82 -} , {}_{0}^{ }{e}{}_{ }^{- k 1 t}\end{matrix} \qquad ( 11 )$$

Both sides are integrated with respect to time t to obtain

C_{SeO42-}=(½)C_{S2O82-,0}(1−e^{-k1t})=(½)(C_{S2O82-,0}−C_{S2O82-}) (12)

That is, the concentration of hexavalent selenium occurring upon the oxidation of tetravalent selenium is not related to the tetravalent selenium concentration, but is determined by the initial peroxodisulfuric acid concentration and the reaction rate constant k₁ of the decomposition reaction of peroxodisulfuric acid.

In the present Experimental Example, in order to investigate the rate of reaction of tetravalent selenium by peroxodisulfuric acid, potassium peroxodisulfate (produced by KANTO CHEMICAL CO., INC., Product No. 32375-00) and selenium dioxide (produced by KANTO CHEMICAL CO., INC., Product No. 37025-30) were dissolved to prepare a plurality of standard solutions having peroxodisulfuric acid concentrations of 0.52 to 2.6 mmol/L (100 to 500 mg/L) and tetravalent selenium concentrations of 0.013 to 0.11 mmol/L (1 to 9 mg/L). The respective standard solutions were held at 50° C. for 20 hours at the longest, and the concentrations of peroxodisulfuric acid, tetravalent selenium, and hexavalent selenium were measured at constant time intervals. It is to be noted that since the oxidation velocity of tetravalent selenium differed according to the concentration of peroxodisulfuric acid, the final holding time was different depending on the standard solution.

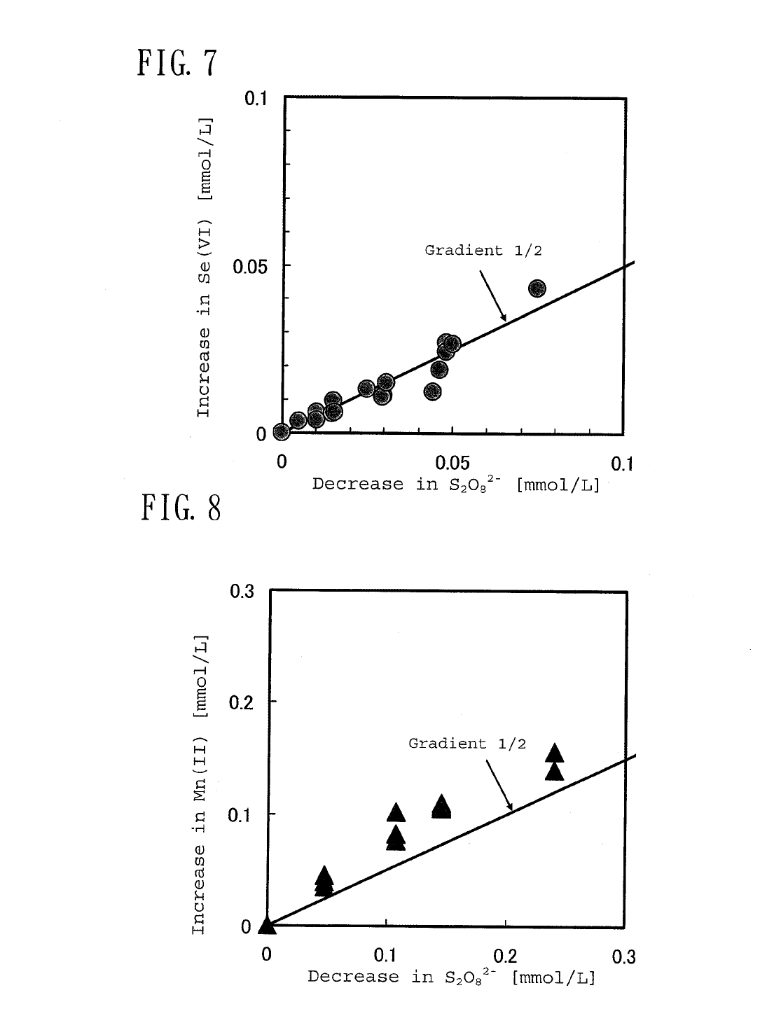

The relationship between the amount of decrease in the peroxodisulfuric acid concentration (the right side of the equation (12)) and the amount of increase in hexavalent selenium (the left side of the equation (12)) after a lapse of the constant holding time of each standard solution is shown in FIG. 7. As shown in FIG. 7, a plot of the measurement results was on a straight line having a gradient of ½, showing that tetravalent selenium and peroxodisulfuric acid reacted at a stoichiometric mixture ratio of 1:2, as shown in the formula (8). The foregoing Examples 1 to 4 show, as stated above, that tetravalent selenium supplies electrons in its reaction with sulfate radicals formed by the decomposition reaction of peroxodisulfuric acid, and that the concentration of hexavalent selenium is determined by the initial peroxodisulfuric acid concentration and the reaction rate constant during decomposition of peroxodisulfuric acid.

(Oxidation of Bivalent Manganese (Mn))

As described above, tetravalent selenium supplies electrons in its reaction with sulfate radicals formed by the decomposition reaction of peroxodisulfuric acid. If there is a substance which supplies electrons more easily than tetravalent selenium, however, electrons are supplied by this substance, and tetravalent selenium supplies electrons with difficulty, so that the oxidation of tetravalent selenium can be suppressed. In the present embodiment, therefore, bivalent manganese which supplies electrons more easily, than tetravalent selenium, in the reaction with sulfate radicals formed by the decomposition reaction of peroxodisulfuric acid is added to suppress the oxidation of tetravalent selenium, as will be shown in Experimental Examples 5 and 6.

That is, in the selenium-containing liquid containing peroxodisulfuric acid, the reaction between sulfate radicals and bivalent manganese is faster than the reaction between sulfate radicals and tetravalent selenium. Thus, if the ratio between the reaction rate constant for the reaction of peroxodisulfuric acid and tetravalent selenium and the reaction rate constant for the reaction of peroxodisulfuric acid and bivalent manganese is known, the bivalent manganese concentration necessary to suppress the oxidation of tetravalent selenium can be set based on the concentration of peroxodisulfuric acid.

In the above-described manner, the bivalent manganese concentration can be set. Thus, the necessary amount of bivalent manganese can be supplied more reliably to the selenium-containing liquid, whereby the oxidation of tetravalent selenium to hexavalent selenium can be suppressed. Thus, the treatment of the selenium-containing liquid can be performed easily. The reasons behind this advantage are that bivalent manganese and tetravalent selenium supply electrons to the reaction with sulfate radicals formed by the decomposition reaction of peroxodisulfuric acid in the present invention, and that since the ratio between the reaction rate constants for their reactions was known, the bivalent manganese concentration could be set based on the reaction rate constant ratio. In the past, these points have not been clarified, so that it has been unknown how much bivalent manganese should be added to the selenium-containing liquid. As a result, there has been a possibility that the bivalent manganese concentration is insufficient, that bivalent manganese is consumed faster than expected and the oxidation of tetravalent selenium proceeds, or that the bivalent manganese concentration is in excess of the required amount.

The points mentioned above will be explained based on Experimental Examples 5 and 6.

### Experimental Example 5

In the present Experimental Example, the oxidation reaction rate of bivalent manganese was investigated.

As stated above, sulfate radicals produced according to the formula (2) immediately deprive the surroundings of electrons, and react as in the formula (3). If the supply source of electrons in the formula (3) is bivalent manganese, tetravalent manganese dioxide is considered to be formed according to the following reaction:

S₂O₈²⁻+e⁻→SO₄⁻+SO₄²⁻ (2)

Mn²⁺+2SO₄⁻+2H₂O→MnO₂+2SO₄²⁻+4H⁺ (13)

The fact that bivalent manganese and peroxodisulfuric acid reacted to form a precipitate of tetravalent manganese (II) dioxide was confirmed by X-ray analysis.

If the reaction rate constants for the formulas (2) and (13) are designated as k₁ and k₃, respectively, the reaction rate of sulfate radicals, r_{SO4-}, is expressed as:

r_{SO4-}=k₁C_{S2O82-}2k₃C_{Mn2+}C_{SO4-}² (14)

The first term of the right side of the equation (14) refers to the formation velocity of the sulfate radicals, and the second term refers to the consumption velocity of the sulfate radicals. The reactivity of radicals, such as sulfate radicals, is so high that the formation velocity of the radicals and the consumption velocity of the radicals can generally be deemed to be equal (nearly steady state). Thus, the following equation is obtained:

C_{SO4-}²=k₁C_{S2O82-}/2k₃C_{Mn2+} (15)

Next, the reaction rate of manganese dioxide, r_{MnO2}, is rearranged using the equation (15) and the equation (5) to provide

$$\begin{matrix}{r}_{MnO 2} = d {C}_{MnO 2} / d t \\ = {k}_{3} {C}_{Mn 2 +} {C}_{SO 4 -}^{2} \\ = ( 1 / 2 ) {k}_{1} {C}_{S 2 O 82 -} \\ = ( 1 / 2 ) {k}_{1} {C}_{S 2 O 82 -} , {}_{0}^{ }{e}{}_{ }^{- k 1 t}\end{matrix} \qquad ( 16 )$$

Both sides are integrated with respect to time t to obtain

C_{MnO2}=(½)C_{S2O82-,0}(1−e^{-k1t})=(½)(C_{S2O82-,0}−C_{S2O82-}) (17)

That is, the concentration of manganese dioxide occurring upon the oxidation of bivalent manganese (i.e., the amount of decrease in the bivalent manganese concentration) is not related to the bivalent manganese concentration, but is determined by the initial peroxodisulfuric acid concentration and the reaction rate constant k₁ of the decomposition reaction of peroxodisulfuric acid.

In the present Experimental Example, in order to investigate the rate of reaction of bivalent manganese by peroxodisulfuric acid, potassium peroxodisulfate (produced by KANTO CHEMICAL CO., INC., Product No. 32375-00) and 1000 ppm of a manganese standard solution (produced by KANTO CHEMICAL CO., INC., Product No. 25824-1B) was dissolved to prepare a plurality of standard solutions having peroxodisulfuric acid concentrations of 0.52 to 2.6 mmol/L (100 to 500 mg/L) and bivalent manganese concentrations of 0.091 to 0.55 mmol/L (5 to 30 mg/L). The respective standard solutions were held at 50° C. for 48 hours at the longest, and the peroxodisulfuric acid concentration and the bivalent manganese concentration were measured at constant time intervals. It is to be noted that since the oxidation velocity of bivalent manganese differed according to the concentration of peroxodisulfuric acid, the final holding time was different depending on the standard solution.

The relationship between the amount of decrease in the peroxodisulfuric acid concentration (the right side of the equation (12)) and the amount of decrease in bivalent manganese (the left side of the equation (12)) after a lapse of the constant holding time of each standard solution is shown in FIG. 8. As shown in FIG. 8, a plot of the measurement results was on a straight line having a gradient of ½, showing that bivalent manganese and peroxodisulfuric acid reacted at a stoichiometric mixture ratio of 1:2, as shown in the equation (17). These findings show, as stated above, that bivalent manganese supplies electrons in its reaction with sulfate radicals formed by the decomposition reaction of peroxodisulfuric acid, and that the concentration of manganese dioxide produced by the oxidation of bivalent manganese is determined by the initial peroxodisulfuric acid concentration and the reaction rate constant during decomposition of peroxodisulfuric acid.

### Experimental Example 6

In the present Experimental Example, reactions in a solution where peroxodisulfuric acid, tetravalent selenium, and bivalent manganese were coexistent were investigated. The reactions which should be considered are as follows:

S₂O₈²⁻+e⁻→SO₄⁻+SO₄²⁻ (2)

Se(IV)O₃²⁻+2SO₄⁻+H₂O→Se(VI)O₄²⁻+2SO₄²⁻+2H⁺ (8)

Mn²⁺+2SO₄⁻+2H₂O→MnO₂+2SO₄²⁻+4H⁺ (13)

If the reaction rate constants for the formulas (2), (8) and (13) are designated as k₁, k₂ and k₃, respectively, the reaction rate of sulfate radicals, r_{SO4-}, is expressed as:

r_{SO4-}=k₁C_{S2O82-}−2k₂C_{SeO32-}C_{SO4-}²−2k₃C_{Mn2+}C_{SO4-}² (18)

The first term of the right side of the equation (18) refers to the formation velocity of the sulfate radicals, and the second and third terms refer to the consumption velocities of the sulfate radicals. The reactivity of radicals, such as sulfate radicals, is so high that the formation velocity of the radicals and the consumption velocity of the radicals can generally be deemed to be equal (nearly steady state). Thus, the following equation is obtained:

C_{SO4-}²=k₁C_{S2O82-}/(2k₂C_{SeO32-}−2k₃C_{Mn2+}) (19)

Next, the reaction rates of tetravalent selenium, hexavalent selenium, bivalent manganese, and manganese dioxide are rearranged using the equation (19) and the equation (5), whereby they are expressed as follows:

r_{SeO32-}=dC_{SeO32-}/dt=−k₁k₂C_{S2O82-,0}e^{-k1t}C_{SeO32-}/(2k₂C_{SeO32-}+2k₃C_{Mn2+}) (20)

r_{SeO42-}=dC_{SeO42-}/dt=k₂k₂C_{S2O82-,0}e^{-k1t}C_{SeO32-}/(2k₂C_{SeO32-}+2k₃C_{Mn2+}) (21)

r_{Mn2+}=dC_{Mn2}+/dt−k₁k₃C_{S2O82-,0}e^{-k1t}C_{Mn2+}/(2k₂C_{SeO32-}+2k₃C_{Mn2+}) (22)

r_{MnO2}=dC_{MnO2}/dt=k₁k₃C_{S2O82-,0}e^{-k1t}C_{Mn2+}/(2k₂C_{SeO32-}+2k₃C_{Mn2+}) (23)

From the equation (21) and the equation (23),

C_{SeO42-}+C_{MnO2}=(½)C_{S2O82-,0}(1−e^{-k1t})=(½)(C_{S2O82-,0}−C_{S2O82-}) (24)

can be obtained. That is, the concentration of hexavalent selenium formed by the oxidation of tetravalent selenium and the concentration of manganese dioxide formed by the oxidation of bivalent manganese (i.e., the amount of decrease in the bivalent manganese concentration) is determined by the initial peroxodisulfuric acid concentration and the reaction rate constant k₁ of the decomposition reaction of peroxodisulfuric acid.

In the present Experimental Example, potassium peroxodisulfate (produced by KANTO CHEMICAL CO., INC., Product No. 32375-00), selenium dioxide (produced by KANTO CHEMICAL CO., INC., Product No. 37025-30), and 1000 ppm of a manganese standard solution (produced by KANTO CHEMICAL CO., INC., Product No. 25824-1B) were dissolved to prepare a plurality of standard solutions having peroxodisulfuric acid concentrations of 0.52 to 2.6 mmol/L (100 to 500 mg/L), tetravalent selenium concentrations of 0.0025 to 0.19 mmol/L (0.2 to 15 mg/L), and bivalent manganese concentrations of 0.036 to 0.36 mmol/L (2 to 20 mg/L). The respective standard solutions were held at 50° C. for 84 hours at the longest, and peroxodisulfuric acid, hexavalent selenium and bivalent manganese were measured at constant time intervals. It is to be noted that since the oxidation velocities of tetravalent selenium and bivalent manganese differed according to the composition of the standard solution, the final holding time was different depending on the sample.

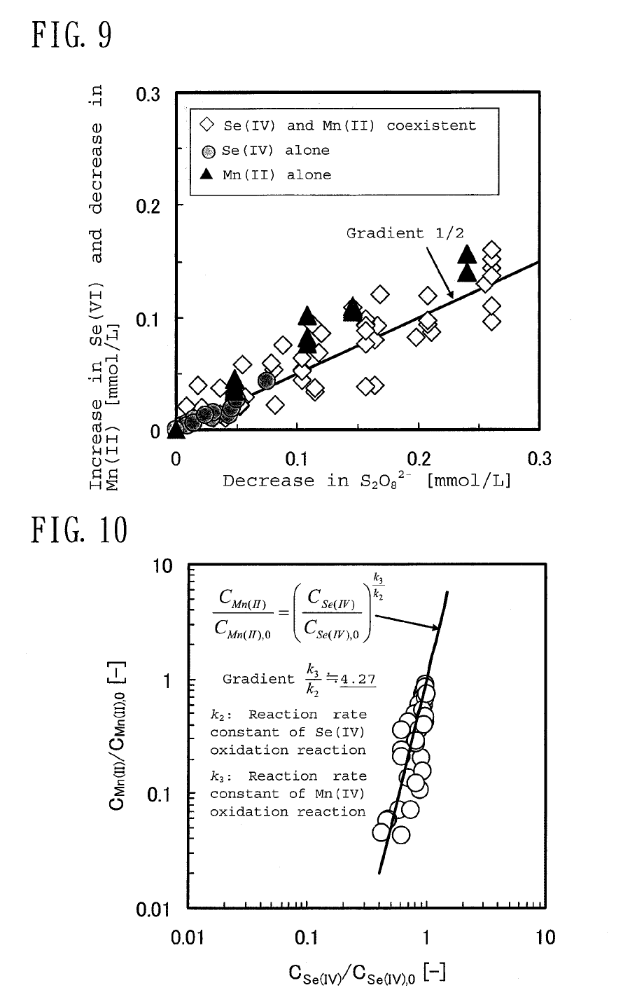

The relationship of the amount of decrease in the peroxodisulfuric acid concentration (the right side of the equation (24)) with the sum of the amount of increase in the hexavalent selenium concentration and the amount of decrease in the bivalent manganese concentration (the left side of the equation (24)) after a lapse of the constant holding time of each standard solution is shown in FIG. 9. For purposes of comparison, the results of Experimental Example 4 involving the addition of only tetravalent selenium to peroxodisulfuric acid (FIG. 7) and the results of Experimental Example 5 involving the addition of only bivalent manganese to peroxodisulfuric acid (FIG. 8) are also shown. As shown in FIG. 9, a plot of the measurement results was on a straight line having a gradient of ½, showing that tetravalent selenium and bivalent manganese, and peroxodisulfuric acid reacted at a stoichiometric mixture ratio of 1:2, as shown in the equation (24).

Next, the following equation is obtained from the equations (20) and (22):

C_{Mn2+}/C_{Mn2+,0}=(C_{SeO32-}/C_{SeO32-,0})^{(k3/k2)} (25)

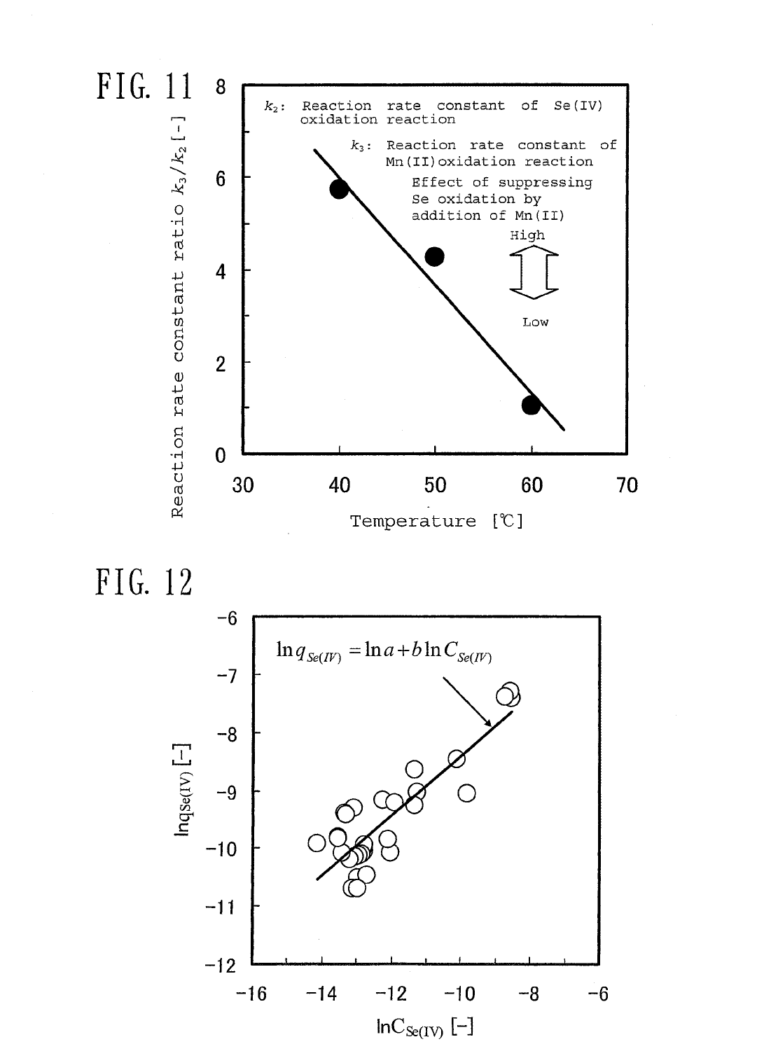

A plot of the relationship between C_{Mn2+}/C_{Mn2+,0} and C_{SeO32-}/C_{SeO32-,0} based on the measurement results of the present Experimental Example is shown in FIG. 10. The plot of the measurement results was nearly on a single straight line, and the gradient of this straight line was about 4.27. That is, this value is k₃/k₂, meaning the ratio between the reaction rate constants of bivalent manganese and tetravalent selenium when oxidized with sulfate radicals. When the temperature of the selenium-containing liquid was 50° C., the contribution of sulfate radicals, which occurred upon decomposition of peroxodisulfuric acid, to the oxidation reaction of bivalent manganese was about 4.27 times the contribution of the sulfate radicals to the oxidation reaction of tetravalent selenium. This finding showed that bivalent manganese was selectively oxidized in the presence of bivalent manganese and tetravalent selenium.

The present Experimental Example showed that in the reaction with sulfate radicals produced by the decomposition reaction of peroxodisulfuric acid, the sulfate radicals deprived bivalent manganese, if any, of electrons or deprived tetravalent selenium, if any, of electrons, with the result that manganese dioxide or hexavalent selenium was formed. It was also found that in the decomposition reaction of peroxodisulfuric acid, if bivalent manganese and tetravalent selenium were present in the solution, sulfate radicals deprived both elements of electrons, but took away electrons from bivalent manganese more easily than from tetravalent selenium.

Based on each of the Examples mentioned above, with the method for treating the selenium-containing liquid according to the present embodiment, a measurement step is performed which measures the initial concentrations of peroxodisulfuric acid and tetravalent selenium in the selenium-containing liquid.

Then, a setting step is performed which sets the bivalent manganese concentration based on the concentration of peroxodisulfuric acid and the concentration of tetravalent selenium, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid.

Specifically, the concentration of peroxodisulfuric acid, the concentration of tetravalent selenium, an arbitrary bivalent manganese concentration, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid are substituted into the aforementioned equations (20) to (23) to calculate the peroxodisulfuric acid concentration, the tetravalent selenium concentration, the hexavalent selenium concentration, and the bivalent manganese concentration at each point in time. Then, a bivalent manganese concentration is set for rendering a hexavalent selenium concentration at a desired time t with respect to the initial tetravalent selenium concentration, namely, the oxidation ratio of tetravalent selenium, a desired value. That is, the oxidation ratio is found from the tetravalent selenium concentration and the hexavalent selenium concentration at each time, and the value of the bivalent manganese concentration when the desired oxidation ratio is reached is set as the bivalent manganese concentration. The reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid are temperature-dependent as will be indicated below. Thus, it is permissible to prestore table data on the reaction rate constant and the reaction rate constant ratio at each temperature, and determine the reaction rate constant and the reaction rate constant ratio based on the table data.

### Experimental Example 7

In the present Experimental Example, the temperature dependence of the reaction rate constant ratio k₃/k₂ was investigated. Potassium peroxodisulfate (produced by KANTO CHEMICAL CO., INC., Product No. 32375-00), selenium dioxide (produced by KANTO CHEMICAL CO., INC., Product No. 37025-30), and 1000 ppm of a manganese standard solution (produced by KANTO CHEMICAL CO., INC., Product No. 25824-1B) were dissolved to prepare a plurality of standard solutions having peroxodisulfuric acid concentrations of 0.52 to 2.6 mmol/L (100 to 500 mg/L), tetravalent selenium concentrations of 0.0025 to 0.19 mmol/L (0.2 to 15 mg/L), and bivalent manganese concentrations of 0.036 to 0.36 mmol/L (2 to 20 mg/L). The respective standard solutions were held at 40° C. and 60° C. for 84 hours at the longest, and the concentrations of peroxodisulfuric acid, hexavalent selenium and bivalent manganese were measured. It is to be noted that since the oxidation velocities of tetravalent selenium and bivalent manganese differed according to the composition of the standard solution, the final holding time was different depending on the standard solution.

From the relationship between C_{Mn2}+/C_{Mn2+,0} and C_{SeO32-}/C_{SeO32-,0}, k₃/k₂ at 40° C. and that at 60° C. were calculated by the same method as in Experimental Example 6. The relationship between the temperature and k₃/k₂ is also shown in FIG. 11, together with the results on k₃/k₂ at 50° C. obtained in Experimental Example 6.

FIG. 11 showed that k₃/k₂ had temperature dependence, and that the lower the temperature, the higher the value of k₃/k₂ was. That is, it was found that since the contribution of sulfate radicals to the oxidation reaction of bivalent manganese was greater than that of tetravalent selenium, the effect of suppressing the oxidation of tetravalent selenium by the addition of bivalent manganese was high.

(Amount of Selenium Adsorbed)

When tetravalent selenium and bivalent manganese coexist, a part of tetravalent selenium is adsorbed to manganese dioxide which is formed by the oxidation of bivalent manganese. The adsorbed tetravalent selenium does not react with sulfate radicals which result from decomposition of peroxodisulfuric acid. As will be shown in Experimental Examples 8 and 9, therefore, consideration of the amount of tetravalent selenium adsorbed to manganese dioxide makes it possible to set, more accurately, the amount of bivalent manganese necessary to suppress the oxidation of tetravalent selenium.

### Experimental Example 8

In the present Experimental Example, the amount of tetravalent selenium adsorbed to manganese dioxide was investigated based on the results obtained in Experimental Example 6. FIG. 12 shows the relationship between the concentration of tetravalent selenium after a lapse of a constant time (obtained in Experimental Example 6) and the amount of tetravalent selenium adsorbed to manganese dioxide per gram of manganese dioxide. The weight of manganese dioxide was found from the amount of decrease in bivalent manganese, and the amount of tetravalent selenium adsorbed to manganese dioxide was calculated from the amount of decrease in the selenium concentration in the liquid.

As shown in FIG. 12, a plot of the experimental results was on a nearly straight line, and took the form of Freundlich's equation which is one of the general formulas concerned with adsorption. The constants a and b were calculated from the gradient and intercept of the straight line. That is, knowledge of the tetravalent selenium concentration in the solution and knowledge of the amount of manganese dioxide calculated from the amount of decrease in bivalent manganese were found to make it possible to calculate the amount of tetravalent selenium adsorbed to manganese dioxide.

Based on these Experimental Examples, in predicting the reactions from the equations (20) to (23), the following procedure taking the amount of tetravalent selenium adsorbed to manganese dioxide into consideration is carried out: A concentration corresponding to the amount of tetravalent selenium adsorbed to manganese dioxide is subtracted from the tetravalent selenium concentration at each time to find the concentration of tetravalent selenium which actually reacts with peroxodisulfuric acid. Based on the actually reacting tetravalent selenium concentration, the bivalent manganese concentration is set, as described above. By so doing, to what extent the formation of hexavalent selenium can be suppressed after how many hours can be estimated more accurately.

### Experimental Example 9

In the present Example, the calculated values and the measured values of concentration changes of tetravalent selenium, hexavalent selenium, and bivalent manganese were compared to confirm the accuracy of the calculations.

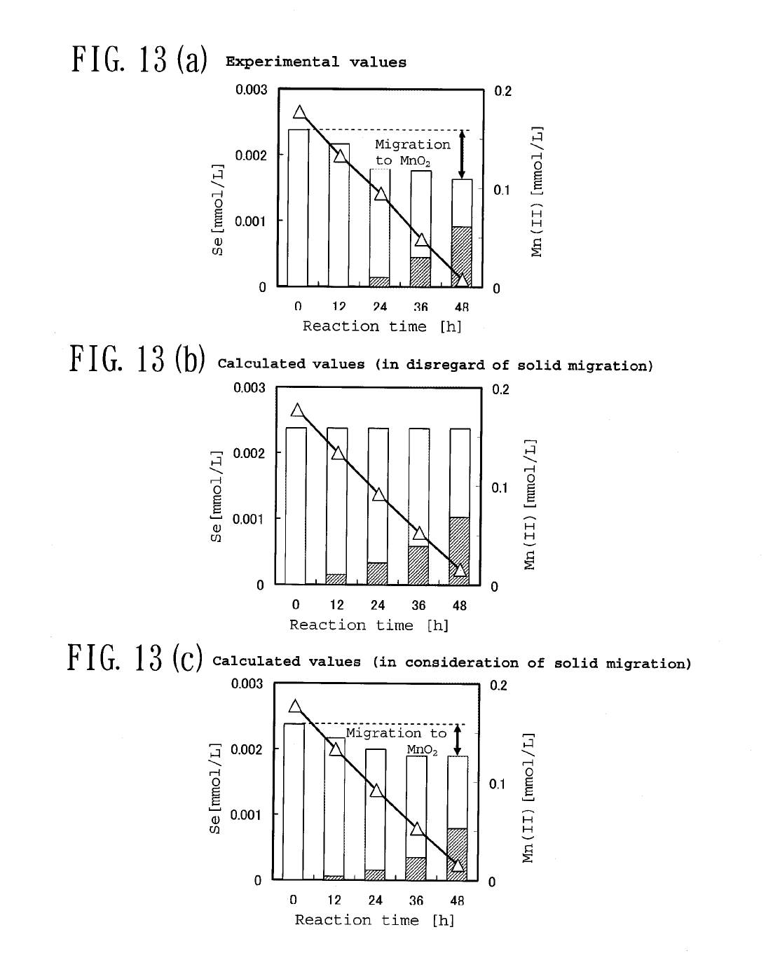

The composition of the standard solution had an initial tetravalent selenium concentration of 0.0024 mmol/L (0.2 mg/L) and an initial bivalent manganese concentration of 0.18 mmol/L (10 mg/L). The initial concentration of peroxodisulfuric acid was 1.56 mmol/L (300 mg/L). The measured values are shown in FIG. 13(a). The results of the calculations without considering the adsorption of tetravalent selenium to manganese dioxide are shown in FIG. 13(b). The results of the calculations taking into consideration the adsorption of tetravalent selenium to manganese dioxide are shown in FIG. 13(c).

A comparison between the measured values as in FIG. 13(a) and the calculated values not considering the adsorption of tetravalent selenium to manganese dioxide as in FIG. 13(b) showed that the bivalent manganese concentrations agreed well, but the selenium concentrations differed. On the other hand, there was good agreement between the measured values as in FIG. 13(a) and the calculation results taking the adsorption of tetravalent selenium to manganese dioxide into consideration as in FIG. 13(c).

With the method for treating the selenium-containing liquid according to the present embodiment, therefore, the setting step further involves estimating the amount of tetravalent selenium adsorbed to manganese dioxide, and subtracting the adsorbed amount of tetravalent selenium from the total amount of tetravalent selenium, thereby accurately determining the amount of tetravalent selenium which can be oxidized to hexavalent selenium. By this procedure, how much the formation of hexavalent selenium can be suppressed can be estimated more accurately, and an appropriate amount of bivalent manganese can be supplied.

That is, the method for treating the selenium-containing liquid according to the present embodiment comprises the concentration measurement step of measuring the initial concentrations of peroxodisulfuric acid and tetravalent selenium in the selenium-containing liquid, the setting step of setting the bivalent manganese concentration as stated above, and the addition step of adding bivalent manganese to the selenium-containing liquid such that the selenium-containing liquid is held at this bivalent manganese concentration, the setting step further including an estimation step of estimating the amount of tetravalent selenium adsorbed to manganese dioxide.

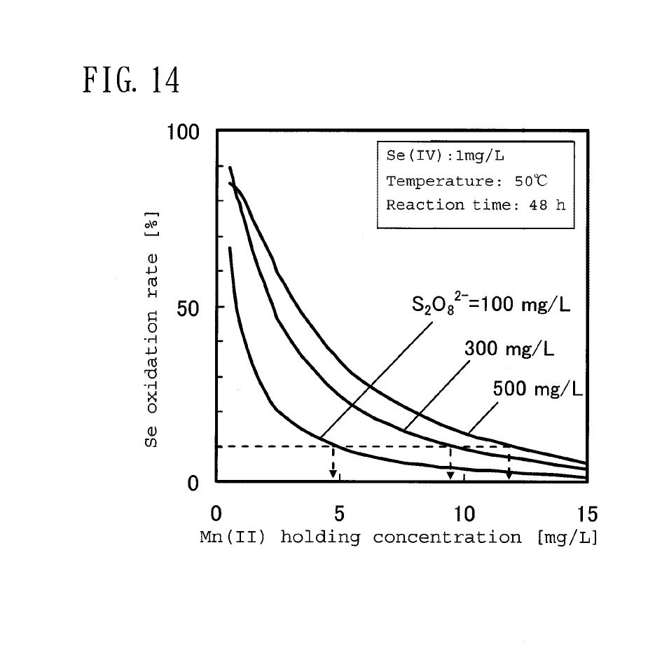

Consequently, for the selenium-containing liquid having a known concentration of peroxodisulfuric acid and a known content of tetravalent selenium, it is possible to know the holding concentration of bivalent manganese necessary for suppressing and restricting the amount of formation of hexavalent selenium after a lapse of a desired time to a value within a permissible range. For example, FIG. 14 shows the selenium oxidation ratio (formation ratios of hexavalent selenium relative to the total amount of selenium) after a lapse of 48 hours when peroxodisulfuric acid concentrations were set at 100 mg/L (0.52 mmol/L), 300 mg/L (1.56 mmol/L) and 500 mg/L (2.6 mmol/L), with the initial concentration of tetravalent selenium being set at 0.013 mmol/L and the holding temperature being kept at 50° C. As shown there, if it is desired to render the above-mentioned oxidation ratio after 48 hours 10% or less, for example, the bivalent manganese concentration needs to be held at about 5 mg/L or more, when the peroxodisulfuric acid concentration is 100 mg/L (0.52 mmol/L).

In the present embodiment, as described above, the peroxodisulfuric acid concentration in the selenium-containing liquid is measured, whereby the bivalent manganese concentration can be set by the setting step so that the selenium oxidation ratio equal to or lower than the desired value is attained. By this procedure, the hexavalent selenium concentration in the selenium-containing liquid becomes lower than before, with tetravalent selenium remaining intact. Thus, treatment can be performed by the coagulation-sedimentation process with ease and at a minimum of cost.

(Treatment System and Wet Flue Gas Desulfurization Device)

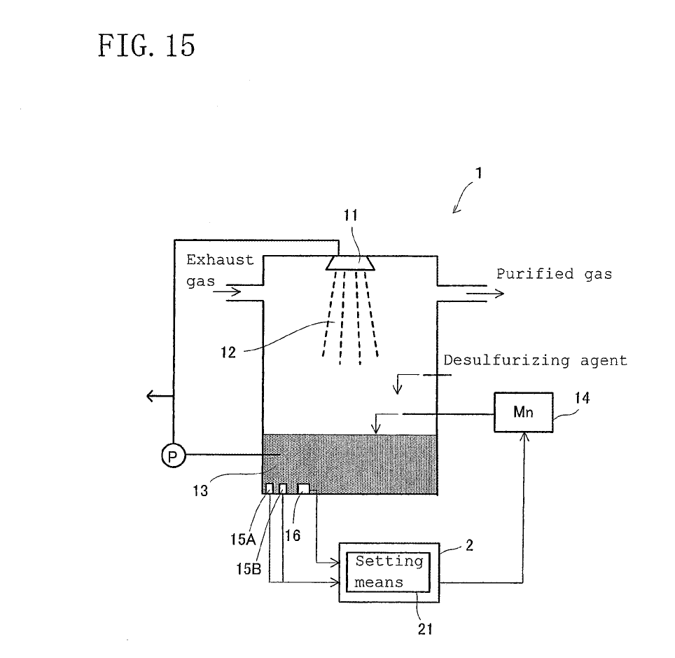

A treatment system for realizing the above-described method for treating the selenium-containing liquid will be explained using FIG. 15.

As shown in FIG. 15, a combustion exhaust gas is introduced into a wet flue gas desulfurization device 1. A desulfurization slurry 12 containing limestone, slaked lime or the like, which will serve as a desulfurizing agent, is sprayed into the wet flue gas desulfurization device 1 by a spray means 11 within the wet flue gas desulfurization device 1 to absorb and remove sulfur in the combustion exhaust gas, whereupon a purified gas is discharged. At this time, gaseous selenium contained in the combustion exhaust gas is considered to be incorporated into a desulfurization slurry 13 stored within the wet flue gas desulfurization device 1. Moreover, the slaked lime or limestone in the desulfurization slurry 13 absorbs sulfur to fix it as stable gypsum (calcium sulfate dehydrate CaSO₄.2H₂O). For this purpose, air for oxidation is supplied to the desulfurization slurry 13, whereby the interior of the wet flue gas desulfurization device 1 is in a strongly oxidizing atmosphere. As a result, there may be a case where peroxodisulfuric acid is formed. The desulfurization slurry 13 is introduced into the spray means 11 by a circulating pump P, and is circulated within the wet flue gas desulfurization device 1. During circulation, a part of the desulfurization slurry 13 is withdrawn. The withdrawn desulfurization slurry 13, as will be described later, is introduced into a gypsum thickener to turn into gypsum. A supernatant portion obtained by solid-liquid separation using the gypsum thickener is introduced, for example, into a waste water treatment device.

As seen above, tetravalent selenium and peroxodisulfuric acid are contained in the desulfurization slurry 13. Thus, if the desulfurization slurry 13 resides for a long time within the wet flue gas desulfurization device 1, tetravalent selenium is oxidized to hexavalent selenium. It is preferred to suppress this oxidation and hold a tetravalent selenium state for a long time. In the present embodiment, therefore, manganese is added to the desulfurization slurry 13, as stated earlier, by a manganese addition means 14. The manganese added by the manganese addition means 14 is added in the state of a bivalent-manganese-containing liquid containing bivalent manganese which reacts with peroxodisulfuric acid. The bivalent-manganese-containing liquid is a solution having a compound of bivalent manganese dissolved therein, or a solution obtained by dissolving zero-valent metallic manganese with an acid or the like.

In this case, in order to determine a bivalent manganese concentration necessary for suppressing the oxidation of tetravalent selenium so that a desired oxidation ratio is attained, the wet flue gas desulfurization device 1 in the present embodiment is equipped with a first concentration measurement means 15A for measuring the concentration of peroxodisulfuric acid in the desulfurization slurry 13, and a second concentration measurement means 15B for measuring the concentration of tetravalent selenium in the desulfurization slurry 13. The wet flue gas desulfurization device 1 is also equipped with a setting means 21 for setting a bivalent manganese concentration based on the concentration of peroxodisulfuric acid and the concentration of tetravalent selenium obtained by these measurement means, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid. The setting means 21 is provided in a control device 2 provided in the wet flue gas desulfurization device 1, and performs the above-described setting step to set the bivalent manganese concentration. In this case, a temperature measurement means 16 for measuring the temperature of the desulfurization slurry 13 is provided within the wet flue gas desulfurization device 1, and a signal indicating the temperature of the desulfurization slurry 13 measured by the temperature measurement means 16 is inputted to the setting means 21. The setting means 21 determines the reaction rate constant ratio based on this temperature, and estimates the amount of tetravalent selenium adsorbed to bivalent manganese to carry out the setting step as described above.

The setting means 21 inputs a signal indicating the set bivalent manganese concentration to the manganese addition means 14. The manganese addition means 14 adds bivalent manganese to the desulfurization slurry 13 such that the bivalent manganese concentration set based on this signal value is reached.

In the present embodiment, as mentioned above, the peroxodisulfuric acid concentration and the tetravalent selenium concentration in the desulfurization slurry 13 can be measured by the first concentration measurement means 15A and the second concentration measurement means 15B, and the bivalent manganese concentration can be set by the setting means 21, so that the desired oxidation ratio is achieved. Thus, hexavalent selenium contained in the desulfurization slurry 13, which is a selenium-containing liquid, can be made to remain as tetravalent selenium. As a result, the amount of hexavalent selenium is decreased as compared with the conventional procedure, and treatment can be performed easily by the coagulation-sedimentation process without involving a high cost. The method of bringing the combustion exhaust gas and the desulfurization slurry into contact in the wet flue gas desulfurization device is not limited to the spray mode shown in FIG. 15, and may be, for example, a bubbling mode in which the gas is directly introduced into the desulfurization slurry. No matter what mode of vapor-liquid contact is adopted, there is no difference in the desulfurization reaction or in the selenium oxidation reaction. Thus, the present embodiment is not limited in the vapor-liquid contact mode of the wet flue gas desulfurization device.

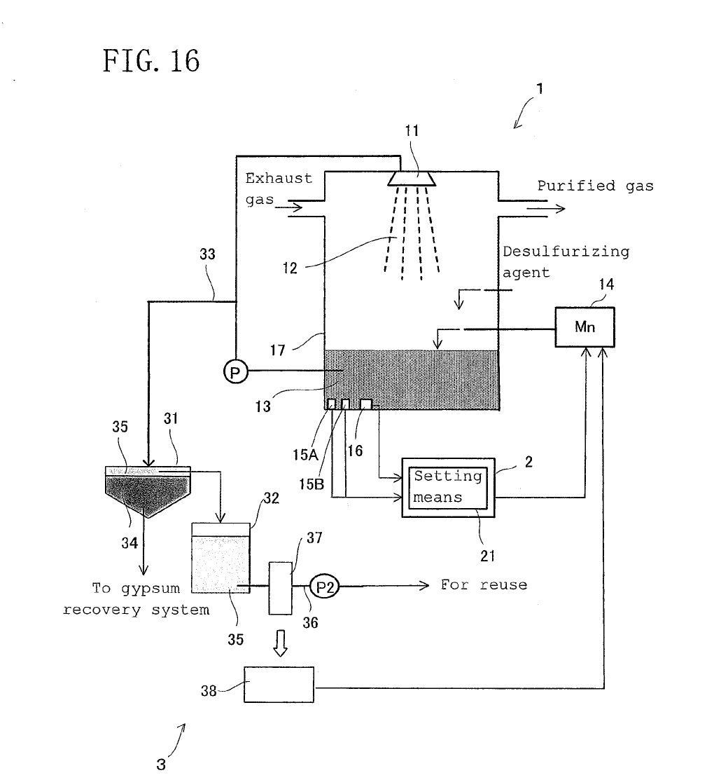

The wet flue gas desulfurization device shown in FIG. 15 may be further provided with a recovery section for manganese dioxide, as shown in FIG. 16. In FIG. 16, the same components as those in FIG. 15 are assigned the same reference symbols as in FIG. 15. That is, manganese dioxide and the unreacted bivalent manganese are contained in the desulfurization slurry 13. Therefore, the wet flue gas desulfurization device shown in FIG. 16 is configured to be capable of recovering manganese dioxide from the desulfurization slurry discharged from an absorption tower 17 of the wet flue gas desulfurization device during circulation, and is also configured to be capable of reusing only the unreacted bivalent manganese in the absorption tower 17 of the wet flue gas desulfurization device 1.

A recovery section 3 for manganese dioxide is provided as a supernatant liquid tank 32 storing a supernatant liquid from a gypsum thickener 31 which is a gypsum thickening device connected to the wet flue gas desulfurization device 1. The supernatant liquid tank is also called a mother liquor tank or a filtrate pit. By the action of a circulating pump P, the desulfurization slurry is introduced into the gypsum thickener 31 via piping 33 during circulation. A neutralization tank for mixing sodium hydroxide or the like with the desulfurization slurry to adjust the pH of the desulfurization slurry may be provided between the wet flue gas desulfurization device and the gypsum thickener.

The desulfurization slurry introduced into the gypsum thickener 31 is stored in the gypsum thickener 31, whereby it is separated by specific gravity into solid gypsum 34 and a supernatant liquid 35 other than gypsum. The separated gypsum 34 is fed out to a gypsum recovery system, where gypsum is formed.

On the other hand, the specific gravity of manganese dioxide formed from bivalent manganese added to the desulfurization slurry is small compared with gypsum, so that the supernatant liquid 35 separated by the gypsum thickener 31 contains manganese dioxide. The supernatant liquid 35 where the manganese dioxide is contained is introduced into the supernatant liquid tank 32.

The supernatant liquid 35 stored in the supernatant liquid tank 32 and containing manganese dioxide is then introduced into piping 36 where a supernatant liquid pump (called a mother liquor pump or filtrate pump) P2 is provided (interposed). In the piping 36, a trapping means 37 constituting the recovery section 3 for manganese dioxide is provided upstream of the supernatant liquid pump P2. The trapping means 37 is intended to trap and recover manganese dioxide in the supernatant liquid, and its shape, etc. are not restricted. Since manganese dioxide is in the form of particles, it suffices for the trapping means 37 to have an opening large enough to be able to catch these particles. In the present embodiment, a reticulated filter is provided as the trapping means 37 within the piping 36. In the present embodiment, in order to suppress the oxidation of tetravalent selenium, bivalent manganese is aggressively added. Thus, the liquid component in the supernatant liquid is practically water, while the solid component contained consists essentially of manganese dioxide. Hence, the solid component trapped by the trapping means 37 is mostly manganese dioxide.

The manganese dioxide trapped by the trapping means 37 is introduced into a dissolution means 38. In the dissolution means 38, the trapped manganese dioxide is dissolved with an acid such as sulfuric acid to become a bivalent-manganese-containing solution containing bivalent manganese. The so trapped manganese dioxide is introduced again as bivalent manganese into the manganese addition means 14, and is added in a predetermined amount, with predetermined timing, to the desulfurization slurry 13 which is a selenium-containing liquid. In this case, hydrochloric acid, nitric acid or the like other than sulfuric acid may be used as the acid used in dissolving manganese, but sulfuric acid is preferred. This is because hydrochloric acid or nitric acid contains chlorine or nitrogen which is an object to be regulated in waste water treatment. Chlorine, in particular, is not preferred, because it serves as a factor for decreasing the efficiency of desulfurization.

On the other hand, the supernatant liquid containing the unreacted bivalent manganese which has not been recovered by the trapping means 37 is partly introduced into a waste water treatment device. Most of the supernatant liquid is introduced, unchanged, into the wet flue gas desulfurization device 1, or is used in preparing a limestone slurry as a desulfurizing agent, or is used as a cleaning fluid for a mist eliminator (not shown) installed in the absorption tower 17. As mentioned above, the supernatant liquid containing the unreacted bivalent manganese is mostly introduced into the wet flue gas desulfurization device, and thus incorporated again into the desulfurization slurry 13. Because of this contrivance, the unreacted bivalent manganese can suppress again the oxidation of tetravalent selenium in the desulfurization slurry 13.

In the present embodiment, as described above, manganese dioxide formed from bivalent manganese used in suppressing the oxidation of selenium can be recovered. If black manganese dioxide is incorporated in white gypsum, the appearance of the gypsum is deteriorated, and the purity of the gypsum declines. This is an undesirable situation. Thus, it is preferred to recover manganese dioxide, thereby suppressing the entry of manganese dioxide into gypsum, as in the present embodiment.

Furthermore, manganese dioxide can be recovered, and dissolved with the acid to form bivalent manganese, as above. Thus, bivalent manganese can be reused, so that the efficiency of utilization of bivalent manganese used in the suppression of oxidation can be increased, whereby the cost can be lowered.

In the foregoing embodiment, a desulfurization slurry was taken out of the desulfurization slurry 13 via the circulating pump P, but this is not limitative. That is, the circulating pump P for circulating the desulfurization slurry 13 within the wet flue gas desulfurization device 1, and a pump for withdrawing a part of the desulfurization slurry 13 may be independent of each other.

In the above embodiment, the trapping means 37 is provided in the piping 36 provided for the supernatant liquid tank 32, but this is not limitative. It suffices for the trapping means 37 to be provided downstream of the gypsum thickener 31.

### EXPLANATIONS OF LETTERS OR NUMERALS

1 Wet flue gas desulfurization device
2 Control device
11 Spray means
12 Slurry
13 Desulfurization slurry
14 Addition means
15A First concentration measurement means
15B Second concentration measurement means
16 Temperature measurement means
21 Setting means
31 Gypsum thickener
32 Supernatant liquid tank
37 Trapping means
P Circulating pump

1. A system for treating a selenium-containing liquid, comprising:
first concentration measurement means for measuring a concentration of peroxodisulfuric acid in the selenium-containing liquid;
second concentration measurement means for measuring a concentration of tetravalent selenium in the selenium-containing liquid;
setting means for setting a bivalent manganese concentration based on the concentration of peroxodisulfuric acid and the concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid; and
addition means for adding bivalent manganese to the selenium-containing liquid such that the selenium-containing liquid has the bivalent manganese concentration,
wherein bivalent manganese is added to the selenium-containing liquid by the addition means such that the bivalent manganese concentration is reached, whereby oxidation of tetravalent selenium to hexavalent selenium is suppressed.

2. The system for treating a selenium-containing liquid according to claim 1, further comprising temperature measurement means for measuring a temperature of the selenium-containing liquid, wherein the setting means sets the reaction rate constant in the decomposition reaction of peroxodisulfuric acid and the reaction rate constant ratio based on the measured temperature.

3. The system for treating a selenium-containing liquid according to claim 1, wherein the setting means estimates an amount of tetravalent selenium deposited on manganese dioxide formed by the reaction between bivalent manganese and peroxodisulfuric acid, subtracts the estimated amount of tetravalent selenium from a total amount of tetravalent selenium to find the concentration of tetravalent selenium, and sets the bivalent manganese concentration based on the concentration of tetravalent selenium.

4. The system for treating a selenium-containing liquid according to claim 1, further comprising recovery means for recovering the manganese dioxide from the selenium-containing liquid to which the bivalent manganese has been added; and dissolution means for dissolving the manganese dioxide, which has been recovered by the recovery means, with an acid to form bivalent manganese.

5. A wet flue gas desulfurization device for removing sulfur oxides in an exhaust gas, comprising:
first concentration measurement means for measuring a concentration of peroxodisulfuric acid in a desulfurization slurry of the wet flue gas desulfurization device, and second concentration measurement means for measuring a concentration of tetravalent selenium in the desulfurization slurry of the wet flue gas desulfurization device;
setting means for setting a bivalent manganese concentration based on the concentration of peroxodisulfuric acid and the concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid; and
addition means for adding bivalent manganese to the selenium-containing liquid such that the selenium-containing liquid has the bivalent manganese concentration,
wherein bivalent manganese is added to the selenium-containing liquid by the addition means such that the bivalent manganese concentration is reached, whereby oxidation of tetravalent selenium to hexavalent selenium is suppressed.

6. The wet flue gas desulfurization device according to claim 5, further comprising a recovery section for recovering the manganese dioxide from a supernatant liquid in gypsum and the supernatant liquid separated by a gypsum thickener which performs solid-liquid separation of the desulfurization slurry from the wet flue gas desulfurization device.

7. The wet flue gas desulfurization device according to claim 6, further comprising dissolution means for dissolving the manganese dioxide, which has been recovered by the recovery section, with an acid to form bivalent manganese.

8. A method for treating a selenium-containing liquid, comprising:
a concentration measurement step of measuring a concentration of peroxodisulfuric acid and a concentration of tetravalent selenium in the selenium-containing liquid;
a setting step of setting a bivalent manganese concentration based on the concentration of peroxodisulfuric acid and the concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid; and
an addition step of adding bivalent manganese to the selenium-containing liquid such that the selenium-containing liquid has the bivalent manganese concentration,
wherein bivalent manganese is added to the selenium-containing liquid, whereby oxidation of tetravalent selenium to hexavalent selenium is suppressed.

9. The system for treating a selenium-containing liquid according to claim 2, wherein the setting means estimates an amount of tetravalent selenium deposited on manganese dioxide formed by the reaction between bivalent manganese and peroxodisulfuric acid, subtracts the estimated amount of tetravalent selenium from a total amount of tetravalent selenium to find the concentration of tetravalent selenium, and sets the bivalent manganese concentration based on the concentration of tetravalent selenium.

10. The system for treating a selenium-containing liquid according to claim 2, further comprising recovery means for recovering the manganese dioxide from the selenium-containing liquid to which the bivalent manganese has been added; and dissolution means for dissolving the manganese dioxide, which has been recovered by the recovery means, with an acid to form bivalent manganese.

11. The system for treating a selenium-containing liquid according to claim 3, further comprising recovery means for recovering the manganese dioxide from the selenium-containing liquid to which the bivalent manganese has been added; and dissolution means for dissolving the manganese dioxide, which has been recovered by the recovery means, with an acid to form bivalent manganese.
